(19) United States
(12) Patent Application Publication
(10) Pub. No.: US 2013/0335576 A1
(43) Pub. Date: Dec. 19, 2013

(54) DYNAMIC ADAPTATION OF IMAGING PARAMETERS

(71) Applicants: Martin GOTSCHLICH, Markt Schwaben (DE); Josef PRAINSACK, Graz (AT); Michael MARK, Graz (AT)

(72) Inventors: Martin GOTSCHLICH, Markt Schwaben (DE); Josef PRAINSACK, Graz (AT); Michael MARK, Graz (AT)

(21) Appl. No.: 13/526,705

(22) Filed: Jun. 19, 2012

(51) Int. Cl. H04N 5/225

(52) U.S. Cl. 348/169

(57) ABSTRACT

Representative implementations of devices and techniques provide adaptable settings for imaging devices and systems. Operating modes may be defined based on whether an object is detected within a preselected area. One or more parameters of emitted electromagnetic radiation may be dynamically adjusted based on the present operating mode.

### BACKGROUND

Imaging systems based on light waves are becoming more widely used for object detection as semiconductor processes have become faster to support such systems. Some imaging systems are capable of providing dozens of images per second, making such systems useful for object tracking as well. While the resolution of such imaging systems may be relatively low, applications using these systems are able to take advantage of the speed of their operation.

Mobile devices such as notebook computers or smart phones are not easily adapted to using such imaging systems due to the power requirements of the imaging systems and the limited power storage capability of the mobile devices. The greatest contributor to the high power requirement of light-based imaging systems is the illumination source, which may be applied at a constant power level and/or constant frequency during operation. Further, such systems may be applied with a constant maximum lateral resolution (i.e., number of pixels) for best performance in worst case usage scenarios. This power demand often exceeds the power storage capabilities of mobile devices, diminishing the usefulness of the imaging systems as applied to the mobile devices.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

For this discussion, the devices and systems illustrated in the figures are shown as having a multiplicity of components. Various implementations of devices and/or systems, as described herein, may include fewer components and remain within the scope of the disclosure. Alternately, other implementations of devices and/or systems may include additional components, or various combinations of the described components, and remain within the scope of the disclosure.

FIG. 1 is an illustration of an example application environment in which the described devices and techniques may be employed, according to an implementation.

FIG. 2 is a block diagram of example imaging system components, according to an implementation.

FIG. 3 is a state diagram of example operating modes and associated imaging parameters, according to an implementation. The state diagram also shows example triggers for switching between operating modes.

FIG. 4 is a flow diagram illustrating an example process for adjusting parameters of an imaging system, according to an implementation.

### DETAILED DESCRIPTION

### Overview

This disclosure is related to imaging systems (imaging systems using emitted electromagnetic (EM) radiation, for example) that are arranged to detect, recognize, and/or track objects in a preselected area relative to the imaging systems. For example, an imaging system may be used to detect and recognize a human hand in an area near a computing device. The imaging system may recognize when the hand is making a gesture, and track the hand-gesture combination as a replacement for a mouse or other input to the computing device.

In one implementation, the imaging system uses distance calculations to detect, recognize, and/or track objects, such as a human hand, for example. The distance calculations may be based on receiving reflections of emitted EM radiation, as the EM radiation is reflected off objects in the preselected area. For example, the distance calculations may be based on the speed of light and the travel time of the reflected EM radiation.

Representative implementations of devices and techniques provide adaptable settings for example imaging devices and systems. The adaptable settings may be associated with various operating modes of the imaging devices and systems and may be used to conserve power. Operating modes may be defined based on whether an object is detected within a preselected area, for example. In one implementation, operating modes are defined based on whether a human hand is detected within the preselected area.

Operating modes may be associated with parameters such as power levels, modulating frequencies, duty cycles, and the like of the emitted EM radiation. One or more parameters of the emitted EM radiation may be dynamically and automatically adjusted based on a present operating mode and subsequent operating modes. For example, a higher power mode may be used by an imaging system when a desired object is detected and a lower power mode may be used when no object is detected. In one implementation, a resolution of a sensor component may be adjusted based on the operating modes.

Various implementations and arrangements for imaging systems, devices, and techniques are discussed in this disclosure. Techniques and devices are discussed with reference to example light-based imaging systems and devices illustrated in the figures. However, this is not intended to be limiting, and is for ease of discussion and illustrative convenience. The techniques and devices discussed may be applied to any of various imaging device designs, structures, and the like (e.g., radiation based, sonic emission based, particle emission based, etc.) and remain within the scope of the disclosure.

Implementations are explained in more detail below using a plurality of examples. Although various implementations and examples are discussed here and below, further implementations and examples may be possible by combining the features and elements of individual implementations and examples.

### Example Imaging System Environment

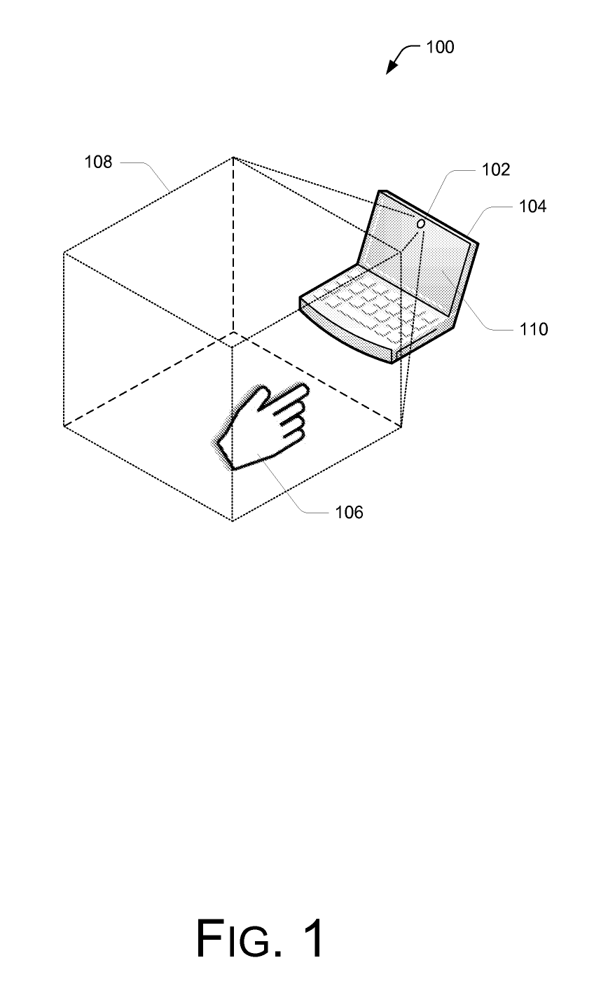

FIG. 1 is an illustration of an example application environment 100 in which the described devices and techniques may be employed, according to an implementation. As shown in the illustration, an imaging system 102 may be applied with a computing device (“mobile device”) 104, for example. The imaging system 102 may be used to detect an object 106, such as a human hand, for example, in a preselected area 108. In one implementation, the imaging system 102 is arranged to detect and/or recognize a gesture of the human hand 106, and may be arranged to track the movement and/or gesture of the human hand 106 as a replacement for a mouse or other input device for the mobile device 104. In an implementation, an output of the imaging system 102 may be presented or displayed on a display device 110, for example (e.g., a mouse pointer or cursor).

In various implementations, the imaging system 102 may be integrated with the mobile device 104, or may have some components separate or remote from the mobile device 104. For example, some processing for the imaging system 102 may be located remotely (e.g., cloud, network, etc.). In another example, some outputs from the imaging system may be transmitted, displayed, or presented on a remote device or at a remote location.

As discussed herein, a mobile device 104 refers to a mobile computing device such as a laptop computer, smartphone, or the like. Examples of a mobile device 104 may include without limitation mobile computing devices, laptop or notebook computers, hand-held computing devices, tablet computing devices, netbook computing devices, personal digital assistant (PDA) devices, reader devices, smartphones, mobile telephones, media players, wearable computing devices, and so forth. The implementations are not limited in this context. Further, stationary computing devices are also included within the scope of the disclosure as a computing device 104, with regard to implementations of an imaging system 102. Stationary computing devices may include without limitation, stationary computers, personal or desktop computers, televisions, set-top boxes, gaming consoles, audio/video systems, appliances, and the like.

An example object 106 may include any item that an imaging system 102 may be arranged to detect, recognize, track and/or the like. Such items may include human body parts, such as all or a portion of a human hand, for example. Other examples of an object 106 may include a mouse, a puck, a wand, a controller, a game piece, sporting equipment, and the like. In various implementations, the imaging system 102 may also be arranged to detect, recognize, and/or track a gesture of the object 106. A gesture may include any movement or position or configuration of the object 106 that is expressive of an idea. For example, a gesture may include positioning a human hand in an orientation or configuration (e.g., pointing with one or more fingers, making an enclosed shape with one or more portions of the hand, etc.) and/or moving the hand in a pattern (e.g., in an elliptical motion, in a substantially linear motion, etc.). Gestures may also be made with other objects 106, when they are positioned, configured, moved, and the like.

The imaging system 102 may be arranged to detect, recognize, and/or track an object 106 that is within a preselected area 108 relative to the mobile device 104. A preselected area 108 may be chosen to encompass an area that human hands or other objects 106 may be within, for example. In one case, the preselected area 108 may encompass an area where hands may be present to make gestures as a replacement for a mouse or other input device. This area may be to the front, side, or around the mobile device 104, for example.

The illustration of FIG. 1 shows a preselected area 108 as a cube-like area in front of the mobile device 104. This is for illustration and discussion purposes, and is not intended to be limiting. A preselected area 108 may be any shape or size, and may be chosen such that it will generally encompass desired objects when they are present, but not encompass undesired objects (e.g., other items that are not intended to be detected, recognized, tracked, or the like). In one implementation, the preselected area 108 may comprise a one foot by one foot cube. In other implementations, the preselected area 108 may comprise other shapes and sizes.

As discussed above, the techniques, components, and devices described herein with respect to an imaging system 102 are not limited to the illustration in FIG. 1, and may be applied to other imaging system and device designs and/or applications without departing from the scope of the disclosure. In some cases, additional or alternative components may be used to implement the techniques described herein. It is to be understood that an imaging system 102 may be implemented as stand-alone system or device, or as part of another system (e.g., integrated with other components, systems, etc.).

### Example Imaging System

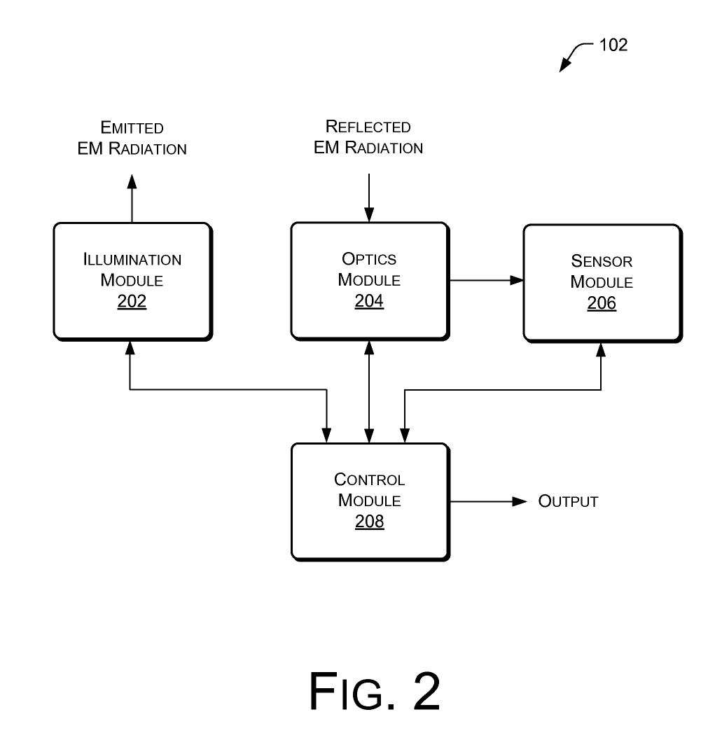

FIG. 2 is a block diagram showing example components of an imaging system 102, according to an implementation. As shown in FIG. 2, an imaging system 102 may include an illumination module 202, an optics module 204, a sensor module 206, and a control module 208. In various implementations, an imaging system 102 may include fewer, additional, or alternate components, and remain within the scope of the disclosure. One or more components of an imaging system 102 may be collocated, combined, or otherwise integrated with another component of the imaging system 102. For example, in one implementation, the imaging system 102 may comprise an imaging device or apparatus. Further, one or more components of the imaging system 102 may be remotely located from the other(s) of the components.

If included in an implementation, the illumination module 202 is arranged to emit electromagnetic (EM) radiation (e.g., light radiation) to illuminate the preselected area 108. In an implementation, the illumination module 202 is a light emitter, for example. In one implementation, the light emitter comprises a light-emitting diode (LED). In another implementation, the light emitter comprises a laser emitter. In one implementation, the illumination module 202 illuminates the entire environment (e.g., the preselected area 108) with each light pulse emitted. In an alternate implementation, the illumination module 202 illuminates the environment in stages or scans.

In various implementations, different forms of EM radiation may be emitted from the illumination module 202. In one implementation, infrared light is emitted. For example, the light radiation may comprise one or more modulated infrared light pulses. The illumination module 202 may be switched on for a short interval, allowing the emitted light pulse to illuminate the preselected area 108, including any objects 106 within the preselected area. Infrared light provides illumination to the preselected area 108 that is not visible to the human eye, and so is not distracting. In other implementations, other types or frequencies of EM radiation may be emitted that provide visual feedback or the like. As mentioned above, in alternate implementations, other energy forms (e.g., radiation based, sonic emission based, particle emission based, etc.) may be emitted by the illumination module 202.

In an implementation, the illumination module 202 is arranged to illuminate one or more objects 106 that may be present in the preselected area 108, to detect the objects 106. In one implementation, a parameter or characteristic of the output of the illumination module 202 (a light pulse, for example) is arranged to be automatically and dynamically adjusted based on whether an object 106 is detected in the preselected area 108. For example, to conserve power, the power output or integration time of the illumination module 202 may be reduced when no object 106 is detected in the preselected area 108 and increased when an object 106 is detected in the preselected area 108. In one implementation, at least one of an illumination time, a duty cycle, a peak power, and a modulation frequency of the light pulse is adjusted based on whether an object 106 is detected within the preselected area 108. In another implementation, at least one of the illumination time, the duty cycle, the peak power, and the modulation frequency of the light pulse is further adjusted based on whether a human hand is detected within the preselected area 108.

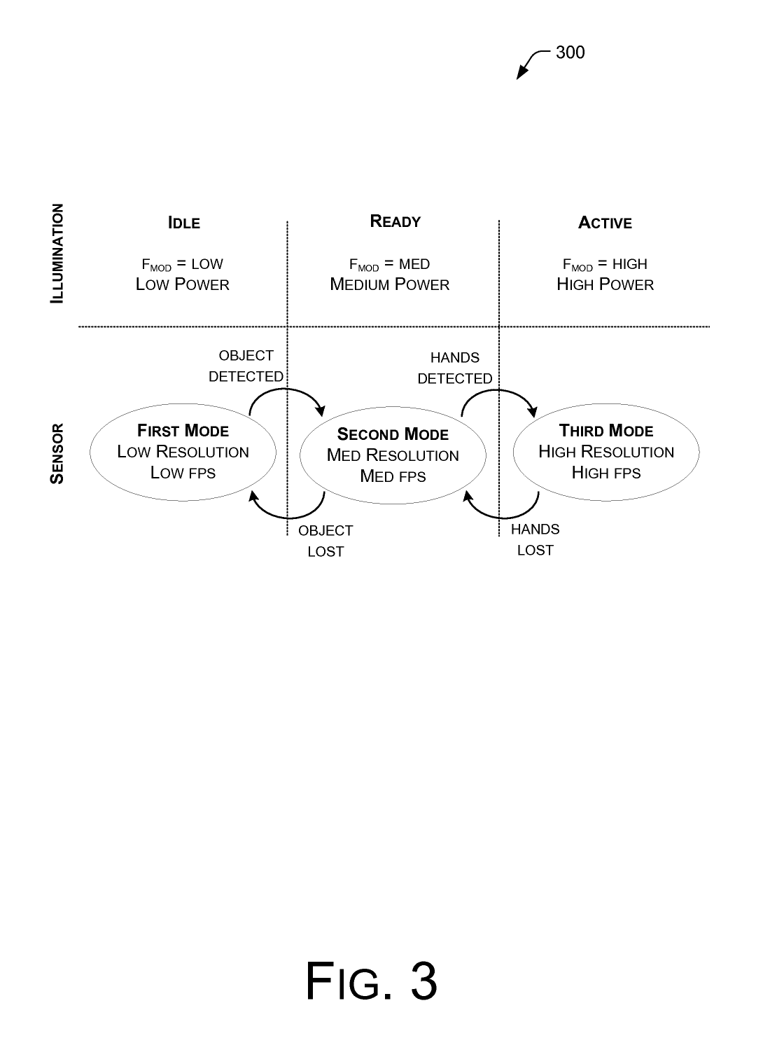

In one implementation, operating modes are defined for the imaging system 102 that are associated with the parameters, characteristics, and the like (e.g., power levels, modulating frequencies, etc.), for the output of the illumination module 202, based on whether an object 106 is detected in the preselected area 108. FIG. 3 is a state diagram 300 showing three example operating modes and the associated imaging system 102 parameters, according to an implementation. The three operating modes are labeled “idle,” (i.e., first operating mode) meaning no object is detected in the preselected area 108; “ready,” (i.e., second operating mode) meaning an object is detected in the preselected area 108; and “active,” (i.e., third operating mode) meaning a human hand is detected in the preselected area 108. In alternate implementations, fewer, additional, or alternate operating modes may be defined and/or used by an imaging system 102 in like manner.

As shown in FIG. 3, the first operating mode is associated with a low modulation frequency (10 MHz, for example) and a low or minimum system power to conserve energy when no object 106 is detected. The second operating mode is associated with a medium modulation frequency (30 MHz, for example) and a medium system power for moderate energy consumption when at least one object 106 is detected. The third operating mode is associated with a higher modulation frequency (80 MHz, for example) and a higher or maximum system power for best performance when at least one human hand is detected. In other implementations, other power values may be associated with the operating modes. System power may include illumination time (time that the EM pulse is “on,” duty cycle, etc.) peak power level, and the like.

In one implementation, as shown in the state diagram 300 of FIG. 3, at least one of an illumination time, a duty cycle, a peak power, and a modulation frequency of the EM radiation are increased when the system is switched from the first operating mode to the second operating mode or from the second operating mode to the third operating mode; and at least one of the illumination time, the duty cycle, the peak power, and the modulation frequency of the light radiation are decreased when the system is switched from the third operating mode to the second operating mode or from the second operating mode to the first operating mode.

If included in an implementation, the optics module 204 is arranged to receive the EM radiation when the EM radiation is reflected off of an object 106. In some implementations, the optics module 204 may include one or more optics, lenses, or other components to focus or direct the reflected EM waves. For example, in other alternate implementations, the optics module 204 may include a receiver, a waveguide, an antenna, and the like.

As shown in FIG. 2, in an implementation, the sensor module 206 is arranged to receive the reflected EM radiation from the optics module 204. In an implementation, the sensor module 206 is comprised of multiple pixels. In one example, each of the multiple pixels is an individual image sensor (e.g., photosensitive pixels, etc.). In such an example, a resulting image from the sensor module 206 may be a combination of the sensor images of the individual pixels. In an implementation, each of the plurality of photosensitive pixels are arranged to convert the reflection of the EM radiation pulse into an electrical current signal. In various implementations, the current signals from the pixels may be processed into an image by one or more processing components (e.g., the control module 208).

In an implementation, the sensor module 206 (or the individual pixels of the sensor module 206) provides a measure of the time for the EM radiation to travel from the illumination module 202, to the object 106, and back to the sensor module 206. Accordingly, in such an implementation, the imaging system 102 comprises a three-dimensional range imaging device arranged to detect an object 106 within the preselected area 108 based on time-of-flight principles.

For example, in one implementation, the sensor module 206 is an image sensor arranged to detect an object 106 within the preselected area 108 based on receiving the reflected EM radiation. The sensor module 206 can detect whether an object is in the preselected area 108 based on the time that it takes for the EM radiation emitted from the illumination module 202 to be reflected back to the sensor module 206. This can be compared to the time that it takes for the EM radiation to return to the sensor module 206 when no object is in the preselected area 108.

In an implementation, the sensor module 206 is arranged to recognize a gesture of at least one human hand or an object 106 within the preselected area 108 based on receiving the reflection of the EM pulse. For example, the sensor module 206 can recognize a human hand, an object 106, and/or a gesture based on the imaging of each individual pixel of the sensor module 206. The combination of each pixel as an individual imaging sensor can result in an image of a hand, a gesture, and the like, based on reflection times of portions of the EM radiation received by the individual pixels. This, in combination with the frame rate of the sensor module 206, allows tracking of the image of a hand, an object, a gesture, and the like. In other implementations, the sensor module 206 can recognize multiple objects, hands, and/or gestures with imaging from the multiple individual pixels.

Further, in an implementation, the sensor module 206 is arranged to distinguish gestures of one or more human hands from other objects 106 within the preselected area 108 and to exclude the other objects 106 when the gestures of the human hands are recognized. In other implementations, the sensor module 206 may be arranged to distinguish other objects 106 in the preselected area 108, and exclude any other items detected.

In one implementation, the sensor module 206 is arranged to determine a distance of a detected object 106 from the imaging system 102, based on receiving the reflected EM radiation. For example, the sensor module 206 can determine the distance of a detected object 106 by multiplying the speed of light by the time taken for the EM radiation to travel from the illumination module 202, to the object 106, and back to the sensor module 206. In one implementation, each pixel of the sensor module 206 is arranged to measure the time for a portion of the EM radiation to travel from the illumination module 202, to the object 106, and back to the pixel.

In an implementation, a lateral resolution of the sensor module 206 is adjustable based on the operating mode of the imaging system 102. As shown in the state diagram 300 of FIG. 3, the first operating mode is associated with a low resolution (10×10 pixels, 5 cm depth resolution, for example) to conserve energy when no object 106 is detected. The second operating mode is associated with a medium resolution (30×30 pixels, 1 cm depth resolution, for example) for moderate energy consumption when at least one object 106 is detected. The third operating mode is associated with a higher resolution (160×160 pixels, 5 mm depth resolution, for example) for best performance when at least one human hand is detected. In other implementations, other resolution values may be associated with the operating modes. In some embodiments, pixels may be controlled to have different resolutions at the same time. For example, in the presence of an object and/or a hand, pixels may be determined based on the image processing of a previous depth or 3D measurement to correspond to either no object, the object or the hand of the object. Different pixel resolutions may then be obtained for those pixels which correspond to no object, object and hand. The pixels with different pixel resolution may further be adapted or tracked for example when the whole objects moves, for example in a lateral direction.

In an additional implementation, to conserve power, the frame rate in frames per second and/or latency of the sensor module 206 may also be adjusted based on the operating mode of the imaging system 102. As shown in FIG. 3, the frames per second of the sensor module 206 may be example values of 2 fps, 10 fps and 60 fps, for the first, second, and third operating modes, respectively. Operating at reduced frame rates conserves power when in the first and second operating modes, when performance is not as important. In alternate implementations, other frame rates may be associated with the operating modes.

In another implementation, power to the modulation drivers for the pixels (and/or to the illumination source/emitter) may be adjusted in like manner based on the operating mode of the imaging system 102. For example the power may be reduced (e.g., minimum power) in the first operating mode, increased in the second operating mode, and further increased (e.g., maximum power) in the third operating mode.

In a further implementation, the sensor module 206 may perform binning of the pixels configured to receive the reflection of the EM radiation. For example, the binning may include combining a group of adjacent pixels and processing the group of pixels as single composite pixel. Increased pixel area may result in higher sensor-sensitivity, and therefore reduce the illumination demand, allowing a power reduction in the emitted EM radiation. This power reduction may be in the form of reduced peak power, reduced integration time, or the like.

If included in an implementation, the control module 208 may be arranged to provide controls and/or processing to the imaging system 102. For example, the control module 208 may control the operating modes of the imaging system 102, control the operation of the other modules (202, 204, 206), and/or process the signals and information output by the other modules (202, 204, 206). In various implementations, the control module 208 is arranged to communicate with one or more of the illumination module 202, optics module 204, and sensor module 206. In some implementations, the control module 208 may be integrated into one or more of the other modules (202, 204, 206), or be remote to the modules (202, 204, 206).

In one implementation, the control module 208 is arranged to determine the operating mode of the imaging system 102 based on whether the EM radiation is reflected off an object 106. Further, the control module 208 may be arranged to determine the operating mode of the imaging system 102 based on whether the object 106 is a human hand. As discussed with respect to the state diagram 300 in FIG. 3, the control module 208 switches the imaging system 102 to the first operating mode when no object 106 is detected within the preselected area 108, the control module 208 switches the imaging system 102 to the second operating mode when an object 106 is detected within the preselected area 108, and the control module 208 switches the imaging system 102 to a third operating mode when at least one human hand is detected within the preselected area 108. In alternate implementations, the control module 208 may be arranged to automatically switch the imaging system 102 between operating modes based on other triggers (e.g., thermal values, power levels, light conditions, etc.)

In an implementation, the control module 208 is arranged to detect, recognize, and/or track a gesture made by one or more hands, or by an object 106. In various implementations, the control module 208 may be programmed to recognize some objects 106 and exclude others. For example, the control module 208 may be programmed to exclude all other objects when at least one human hand is detected. The control module 208 may also be programmed to recognize and track certain gestures associated with inputs or commands to the mobile device 104, and the like. In one example, the control module 208 may set the imaging system 102 to the third operating mode when tracking a gesture, to ensure the best performance, and provide the most accurate read of the gesture.

In one implementation, the control module 208 is arranged to calculate a distance of the object 106 from the imaging system 102, based on the measured time of the reflected EM radiation. Accordingly, the control module 208 may be arranged to convert the current signal output from the sensor module 206 (or from the pixels of the sensor module 206) to a distance of the object 106 from the imaging system 102. Further, in an implementation, the control module 208 may be arranged to convert the current signal to a three-dimensional image of the object 106. In one implementation, the control module 208 is arranged to output the calculated distance and/or the three-dimensional image of the object 106. For example, the imaging system 102 may be arranged to output a distance, a three-dimensional image of the detected object 106, tracking coordinates of the object 106, and so forth, to a display device, to another system arranged to process the information, or the like.

In various implementations, additional or alternative components may be used to accomplish the disclosed techniques and arrangements.

### Representative Process

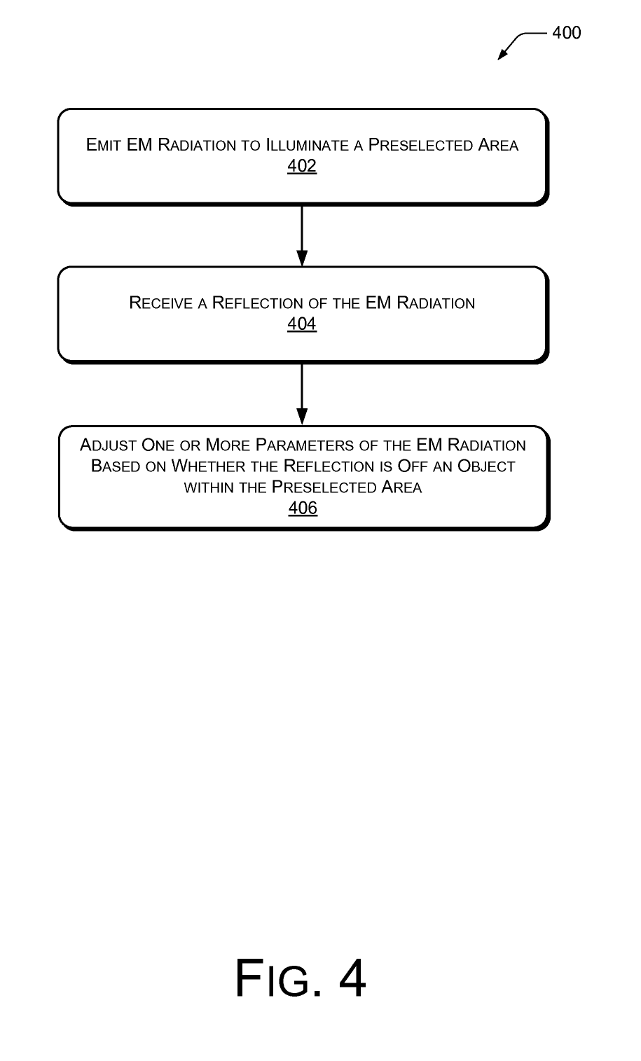

FIG. 4 illustrates a representative process 400 for adjusting parameters of an imaging system (such as imaging system 102). The process 400 describes detecting one or more objects (such as an object 106) in a preselected area (such as preselected area 108). One or more parameters of emitted electromagnetic (EM) radiation may be adjusted based on whether an object is detected in the preselected area. The process 400 is described with reference to FIGS. 1-3.

The order in which the process is described is not intended to be construed as a limitation, and any number of the described process blocks can be combined in any order to implement the process, or alternate processes. Additionally, individual blocks may be deleted from the process without departing from the spirit and scope of the subject matter described herein. Furthermore, the process can be implemented in any suitable materials, or combinations thereof, without departing from the scope of the subject matter described herein.

At block 402, the process includes emitting electromagnetic (EM) radiation to illuminate a preselected area. In one example, the EM radiation may be emitted by an emitter (such as illumination module 202) comprising an LED or laser emitter, for example. In various implementations, the EM radiation comprises a modulated infrared light pulse. In various implementations, the preselected area may be relative to a computing device (such as mobile device 104), such as to provide an input to the computing device, for example.

At block 404, the process includes receiving a reflection of the EM radiation. For example, the reflection of the EM radiation may be received by an imaging sensor (such as sensor module 206). The EM reflection may be received by the imaging sensor via optics, a receiver, an antenna, or the like, for instance.

In various implementations, the process may include detecting, recognizing, and/or tracking an object, a human hand, and/or a gesture of the object or human hand.

At block 406, the process includes adjusting one or more parameters of the EM radiation based on whether the reflection of the EM radiation is reflected off an object within the preselected area. In various implementations, the one or more parameters of the EM radiation may include an illumination time, a duty cycle, a peak power, and a modulation frequency of the electromagnetic radiation. One or more parameters may be increased when an object is detected, and decreased when no object is detected, for example.

In a further implementation, the process includes adjusting the one or more parameters of the EM radiation based on whether the reflection of the EM radiation is reflected off a human hand within the preselected area. One or more parameters may be further increased when a hand is detected, and decreased when no hand is detected, for example.

In one implementation, the process includes adjusting one or more parameters of the imaging sensor based on whether the reflection of the EM radiation is reflected off an object within the preselected area. In various implementations, the one or more parameters of the imaging sensor may include a lateral resolution (in number of pixels), a depth resolution (in distance, for example), and a frame rate (in frames per second, for example).

In another implementation, the process includes binning pixels configured to receive the reflection of the EM radiation. For example, the binning may include combining the signals from a group of adjacent pixels and processing the combined signal of the group of pixels as single composite pixel.

In an implementation, the process further includes measuring a time from emitting the EM radiation to receiving the reflection of the EM radiation and calculating a distance of an object based on the measured time. In a further implementation, the process includes outputting imaging information, such as a distance, a three-dimensional image of the detected object, tracking coordinates of the object, and so forth, to a display device, to another system arranged to process the information, or the like.

In alternate implementations, other techniques may be included in the process 400 in various combinations, and remain within the scope of the disclosure.

### CONCLUSION

Although the implementations of the disclosure have been described in language specific to structural features and/or methodological acts, it is to be understood that the implementations are not necessarily limited to the specific features or acts described. Rather, the specific features and acts are disclosed as representative forms of implementing example devices and techniques. It is to be noted that each of the claims may stand as a separate embodiment. However, other embodiments are provided by combining one or more features of an independent or dependent claim with features of another claim even when no reference is made to this claim.

What is claimed is:

1. An apparatus, comprising:
an emitter arranged to emit a modulated light pulse, a characteristic of the light pulse adjustable based on whether an object is detected within a preselected area relative to the apparatus; and
an image sensor arranged to detect the object within the preselected area based on receiving a reflection of the light pulse.

2. The apparatus of claim 1, the image sensor comprising a plurality of photosensitive pixels arranged to convert the reflection of the light pulse into a current signal.

3. The apparatus of claim 2, further comprising a control module arranged to at least one of convert the current signal to a distance of the object from the apparatus and convert the current signal to a three-dimensional image of the object.

4. The apparatus of claim 1, wherein the emitter comprises one of a light-emitting-diode (LED) or a laser emitter.

5. The apparatus of claim 1, wherein at least one of an illumination time, a duty cycle, a peak power, and a modulation frequency of the light pulse is adjusted based on whether an object is detected within the preselected area.

6. The apparatus of claim 5, wherein the at least one of the illumination time, the duty cycle, the peak power, and the modulation frequency of the light pulse is further adjusted based on whether a human hand is detected within the preselected area.

7. The apparatus of claim 1, wherein the image sensor is arranged to recognize a gesture of at least one human hand within the preselected area based on receiving the reflection of the light pulse.

8. The apparatus of claim 7, wherein the image sensor is arranged to distinguish the gesture of the at least one human hand from other objects within the preselected area and to exclude the other objects when the gesture of the at least one human hand is recognized.

9. The apparatus of claim 1, wherein the apparatus comprises a three-dimensional imaging device arranged to detect an object within the preselected area based on time-of-flight principles.

10. A system, comprising:
an illumination module arranged to emit light radiation, one or more parameters of the light radiation adjustable based on an operating mode of the system;
an optics module arranged to receive the light radiation when the light radiation is reflected off of an object;
a sensor module arranged to receive the light radiation from the optics module and measure a time for the light radiation to travel from the illumination module, to the object, and to the sensor module; and
a control module arranged to calculate a distance of the object from the system based on the measured time, the control module further arranged to determine the operating mode of the system based on whether the light radiation is reflected off the object.

11. The system of claim 10, wherein the sensor module comprises multiple pixels, each pixel of the sensor module arranged to measure the time for a portion of the light radiation to travel from the illumination module, to the object, and to the pixel.

12. The system of claim 11, wherein a resolution of the sensor module is adjustable based on prior image processing performed by the sensor module.

13. The system of claim 11, wherein a lateral resolution of the sensor module is adjustable based on the operating mode of the system.

14. The system of claim 10, wherein the control module is further arranged to determine the operating mode of the system based on whether the object is a human hand.

15. The system of claim 10, wherein the light radiation comprises one or more modulated infrared light pulses.

16. The system of claim 10, wherein the control module switches the system to a first operating mode when no object is detected within a preselected area, the control module switches the system to a second operating mode when an object is detected within the preselected area, and the control module switches the system to a third operating mode when at least one human hand is detected within the preselected area.

17. The system of claim 16, wherein at least one of an illumination time, a duty cycle, a peak power, and a modulation frequency of the light radiation are increased when the system is switched from the first operating mode to the second operating mode or from the second operating mode to the third operating mode, and wherein the at least one of the illumination time, the duty cycle, the peak power, and the modulation frequency of the light radiation are decreased when the system is switched from the third operating mode to the second operating mode or from the second operating mode to the first operating mode.

18. The system of claim 10, wherein the control module is further arranged to output at least one of the calculated distance and a three-dimensional image of the object.

19. A method, comprising:
emitting electromagnetic radiation to illuminate a preselected area;
receiving a reflection of the electromagnetic radiation; and
adjusting one or more parameters of the electromagnetic radiation based on whether the reflection of the electromagnetic radiation is reflected off an object within the preselected area.

20. The method of claim 19, further comprising adjusting the one or more parameters of the electromagnetic radiation based on whether the reflection of the electromagnetic radiation is reflected off a human hand within the preselected area.

21. The method of claim 20, further comprising recognizing a gesture of the at least one human hand.

22. The method of claim 19, further comprising measuring a time from emitting the electromagnetic radiation to receiving the reflection of the electromagnetic radiation and calculating a distance of an object based on the measured time.

23. The method of claim 19, further comprising binning pixels configured to receive the reflection of the electromagnetic radiation, the binning including combining a group of adjacent pixels and processing the group as single composite pixel.

24. The method of claim 19, wherein the one or more parameters of the electromagnetic radiation include at least one of an illumination time, a duty cycle, a peak power, and a modulation frequency of the electromagnetic radiation.

25. The method of claim 19, wherein the electromagnetic radiation comprises a modulated infrared light pulse.

26. A range imaging device, comprising:
a light emitter arranged to emit a modulated light pulse, at least one of an illumination time, a duty cycle, a peak power, and a modulation frequency of the light pulse being automatically adjustable based on whether an object is detected in a preselected area relative to the range imaging device; and
an image sensor arranged to determine a distance of an object from the range imaging device based on receiving a reflection of the light pulse.
